(19) United States
(12) Patent Application Publication
(10) Pub. No.: US 2009/0107473 A1
(43) Pub. Date: Apr. 30, 2009

(54) Cold start structure for multipoint fuel injection systems

(75) Inventors: William J. Imoehl, Williamsburg, VA (US); Michael J. Hornby, Williamsburg, VA (US)

Correspondence Address: Manelli Denison & Selter PLLC, 2000 M Street. N.W., Suite 700, Washington, DC, 20036, US

(73) Assignee: Continental Automotive Systems US, Inc., Auburn Hills, MI (US)

(21) Appl. No.: 12/285,536

(22) Filed: Oct. 8, 2008

Related U.S. Application Data
(60) Provisional application No. 60/982,916, filed on Oct. 26, 2007.

(51) Int. Cl. F02M 31/125; B05B 1/24; F02M 51/06

(52) U.S. Cl. 123/549; 239/135; 123/472

(57) ABSTRACT

Cold start structure (10) for a fuel injection system includes a fuel rail (12) constructed and arranged to receive a source of fuel. A plurality of fuel injectors (14) is provided with each fuel injector being mounted to the fuel rail to receive fuel. Each fuel injector includes an injector body (24) having an inlet (22) and an outlet (25) and valve structure (26) in the injector body movable between open and closed positions to control flow of fuel from the outlet. Heating structure (16) is associated with each fuel injector and includes a main body (18) mounted to a portion of the fuel rail and a heating element (20) mounted with respect to the main body and extending through the fuel rail, into the inlet of the associated fuel injector, and extending into the injector body of the associated fuel injector.

This application claims the benefit of the earlier filing date of U.S. Provisional Application No. 60/982,916, filed on Oct. 26, 2007, which is incorporated by reference herein in its entirety.

### FIELD OF THE INVENTION

This invention relates to cold start structure for low pressure multi-point fuel injection systems and, more particularly, to structure that includes heating elements mounted on the fuel rail with their tips extending into the injector inlets.

### BACKGROUND OF THE INVENTION

To reduce the dependency on mineral oil based fuels, there is currently a great deal of interest in renewable fuels. The current fuel of choice for spark ignition engines is ethanol or mixtures of gasoline and ethanol. Due to the vapor phase characteristics of ethanol, engines running on pure ethanol (E100) or mixtures of ethanol and water will not start below ambient temperatures of 15° C. to 20° C. In markets where mixtures of up to 85% ethanol and gasoline (E85) are legislated, the minimum start temperature is lower, at −15° C. to −20° C. In the Brazilian market (E100) minimum required start temperatures are −5° C. to −10° C. and in Sweden and North America, −30° C. to −40° C. are typical requirements. A solution to this cold temperature start issue is to heat the injected fuel during start-up.

The current solution in Brazil (E100) is to have a small underhood gasoline tank and simple cold start injector and pump to inject gasoline into the intake manifold during cold start conditions. The disadvantages of this system include fuel aging during warm months causing a no start condition when the weather gets cold, a fire risk when filling the underhood tank with a hot engine, and the necessity of a second fuel.

The current solution for the E85 market is a winter blend fuel of E50 or E70 and, in Sweden, a block heater. The disadvantages of these solutions include the use of these vehicles in markets were there is no block heater infrastructure, such as the rest of Europe or North America or in unexpectedly cold weather when the winter blend fuel is not available.

Commonly owned, U.S. Patent Application Publication No. 20070235557, the content of which is hereby incorporated by reference into this specification, discloses a heated injector that uses inductive heating of the valve body. In addition to the very rapid heat-up of valve body facilitated by inductive heating, the advantage of this concept is that all the fuel of the first injection is heated. That is, there is no fuel between the heater and the valve. Among the disadvantages of the concept is the cost of the electronics required to drive the inductive heating coil.

Another solution has a heated fuel rail concept using a glow plug type device that heats the fuel in the rail. This concept suffers from a great deal of unheated fuel in the injector and low heat-up times due to the large volume of fuel that must be heated.

Thus, there is a need in a cold start structure for multi-point injection systems to heat fuel at start-up while avoiding the above-mentioned issues.

### SUMMARY OF THE INVENTION

An object of the invention is to fulfill the need referred to above. In accordance with the principles of the present invention, this objective is achieved by providing cold start structure for a fuel injection system. The structure includes a fuel rail constructed and arranged to receive a source of fuel. A plurality of fuel injectors is provided with each fuel injector being mounted to the fuel rail to receive fuel.

Each fuel injector includes an injector body having an inlet and an outlet and valve structure in the injector body movable between open and closed positions to control flow of fuel from the outlet. The cold start structure includes heating structure associated with each fuel injector. The heating structure includes a main body mounted to a portion of the fuel rail and a heating element mounted with respect to the main body and extending through the fuel rail, into the inlet of the associated fuel injector, and extending into the injector body of the associated fuel injector.

In accordance with another aspect of an embodiment, cold start structure for a fuel injection system includes a fuel rail constructed and arranged to receive a source of fuel, and a plurality of fuel injectors. Each fuel injector is mounted to the fuel rail to receive fuel. Each fuel injector includes an injector body having an inlet and an outlet, and means, in the injector body movable between open and closed positions, for controlling flow of fuel from the outlet. The cold start structure includes heating structure associated with each fuel injector. Each heating structure includes a main body mounted to a portion of the fuel rail, and means for heating fuel, mounted with respect to the main body and extending through the fuel rail, into the inlet of the associated fuel injector and extending into the injector body of the associated fuel injector.

In accordance with another aspect of an embodiment, a method of heating ethanol based fuel for an internal combustion engine includes the steps of providing a fuel rail receiving a source of ethanol based fuel, providing a plurality of fuel injectors mounted to the fuel rail. Each fuel injector has an injector body including an inlet for receiving the fuel and an outlet for expelling fuel. Heating structure is associated with each fuel injector. Each heating structure is mounted to the fuel rail and has a heating element extending through the fuel rail and into the inlet of the associated fuel injector. The method causes heating of the heating elements to heat the fuel prior to being expelled from the outlets of the fuel injectors.

Other objects, features and characteristics of the present embodiment, as well as the methods of operation and the functions of the related elements of the structure, the combination of parts and economics of manufacture will become more apparent upon consideration of the following detailed description and appended claims with reference to the accompanying drawings, all of which form a part of this specification.

### BRIEF DESCRIPTION OF THE DRAWINGS

The invention will be better understood from the following detailed description of the preferred embodiments thereof, taken in conjunction with the accompanying drawings, wherein like reference numerals refer to like parts, in which:

FIG. 1 is a view of cold start structure for low pressure multi-point fuel injection, showing fuel injectors with associated heating structure mounted to a fuel rail in accordance with an example embodiment of the present invention.

FIG. 2 is a sectional view of a fuel injector with heating structure of FIG. 1.

### DETAILED DESCRIPTION OF AN EXAMPLE EMBODIMENT

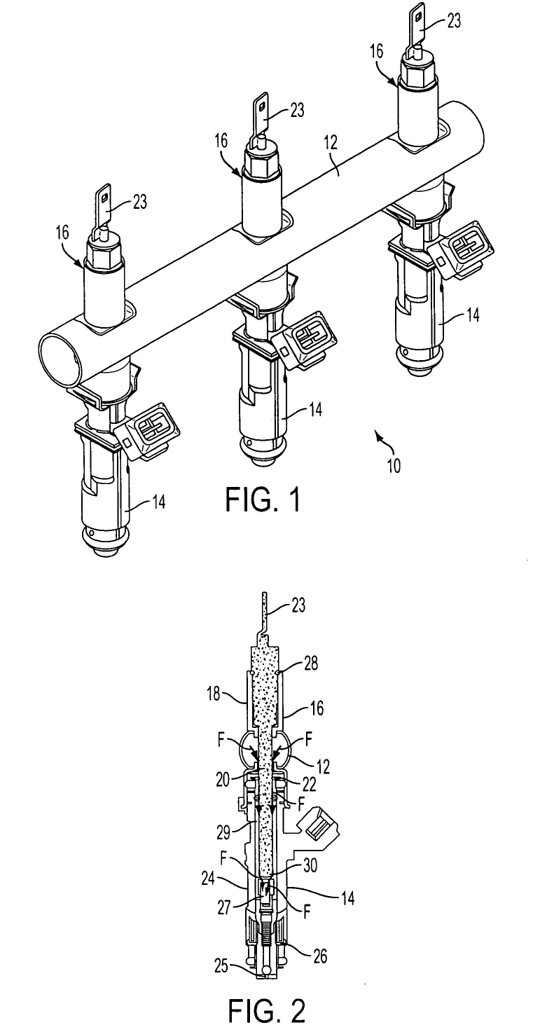

Referring to FIG. 1, a cold start system for low pressure, multi-point fuel injection is shown, generally indicated at 10, for an internal combustion engine. The system 10 includes a fuel rail 12 constructed and arranged to receive a source of fuel for supplying the fuel (preferably ethanol (E100) or mixtures of gasoline and ethanol (E85)) to a plurality of fuel injectors 14 mounted to a bottom portion of the fuel rail 12. Heating structure, generally indicated at 16, is associated with each fuel injector 14.

With reference to FIG. 2, each heating structure 16 includes a main body 18, preferably of stainless steel, mounted to a top portion of the fuel rail 12. For example, the main body 18 can be brazed or soldered to the fuel rail 12. A heating element 20 is mounted with respect to the main body 18 and extends through the fuel rail 12 and into an inlet 22 of the associated fuel injector 14. The heating element 20 is preferably a resistive, Positive Temperature Coefficient (PTC) element or a ceramic element. These types of heating elements 20 provide very fast heat-up times, are self-regulating and thus do not require an external electronic driver. A simple relay (not shown) to supply battery voltage to electrical connector 23 is all that is required for control and thus to cause heating of the heating element 20.

The fuel injector 14 has an elongated injector body 24 having an inlet tube 29. A filter 27 is disposed in the inlet tube 29 that defines the inlet 22, and a valve structure 26 is disposed downstream of the filter 27. The heating element 20 is constructed and arranged to extend deep into the inlet tube 29 (e.g., at least about one half the length of the inlet tube 29) so that an end 30 of the heating element 20 is generally adjacent to the filter 27. This minimizes the mount of unheated fuel between the heating element 20 and valve structure 26 of the fuel injector 14. The valve structure 26, downstream of the heating element 20 and filter 27, is a conventional solenoid-operated valve movable between open and closed positions, preferably of the type disclosed in U.S. Pat. No. 6,685,112 B1, the contents of which is hereby incorporated herein by reference. Thus, when the valve structure 26 is open, fuel F at the inlet 22 passes around the periphery of the heating element 20 and is heated prior to being expelled from the outlet 25 of the injector body 24.

The heating element 20 is in the form of a cartridge. Thus, sealing to the fuel system is simple and can use standard O-ring technology. For example, O-ring 28 seals the heating element 20 with respect to the body 18. Since the heating element is encased in the body 18 defining a cartridge, there is no need of ensuring that electrical conductors are out of the fuel path without leakage as is the case with conventional heaters.

Thus, the heating structure 16 ensures that fuel, such as E85 or E100, expelled from the outlet 25 of each injector is heated sufficiently so that cold start requirements are met.

The foregoing preferred embodiments have been shown and described for the purposes of illustrating the structural and functional principles of the present invention, as well as illustrating the methods of employing the preferred embodiments and are subject to change without departing from such principles. Therefore, this invention includes all modifications encompassed within the scope of the following claims.

What is claimed is:

1. Cold start structure for a fuel injection system, the cold start structure comprising:
a fuel rail constructed and arranged to receive a source of fuel,
a plurality of fuel injectors, each fuel injector being mounted to the fuel rail to receive fuel, and each fuel injector comprising:
an injector body having an inlet and an outlet; and
valve structure, in the injector body, movable between open and closed positions to control flow of fuel from the outlet, and
heating structure associated with each fuel injector, each heating structure comprising:
a main body mounted to a portion of the fuel rail, and
a heating element mounted with respect to the main body and extending through the fuel rail, into the inlet of the associated fuel injector and extending into the injector body of the associated fuel injector.

2. The structure of claim 1, wherein the heating element is one of a Positive Temperature Coefficient (PTC) element or a ceramic element constructed and arranged such that fuel may flow around a periphery of the heating element.

3. The structure of claim 2, wherein the valve structure is disposed downstream of the heating element so as to control flow of heated fuel from the outlet.

4. The structure of claim 1, wherein each fuel injector includes an inlet tube defining the inlet and extending into the injector body, a portion of the heating element being disposed in the inlet tube.

5. The structure of claim 4, wherein a filter is disposed in the inlet tube between an end of the heating element and the valve structure, the end of the heating element being generally adjacent to the filter.

6. The structure of claim 1, wherein an O-ring seals the heating element with respect to the main body.

7. The structure of claim 1, wherein the valve structure is solenoid operated.

8. The structure of claim 1, wherein each heating structure includes an electrical connector constructed and arranged to receive battery voltage to cause heating of the heating element.

9. The structure of claim 1, in combination with fuel, the fuel being at least one of E85 or E100.

10. Cold start structure for a fuel injection system, the cold start structure comprising:
a fuel rail constructed and arranged to receive a source of fuel,
a plurality of fuel injectors, each fuel injector being mounted to the fuel rail to receive fuel, and each fuel injector comprising:
an injector body having an inlet and an outlet; and
means, in the injector body and movable between open and closed positions, for controlling flow of fuel from the outlet, and
heating structure associated with each fuel injector, each heating structure comprising:
a main body mounted to a portion of the fuel rail, and
means for heating fuel, mounted with respect to the main body and extending through the fuel rail, into the inlet and extending into the injector body of an associated fuel injector.

11. The structure of claim 10, wherein the means for heating is one of a Positive Temperature Coefficient (PTC) element or a ceramic element constructed and arranged such that fuel may flow around a periphery of the heating element.

12. The structure of claim 10, wherein the means for controlling is disposed downstream of the means for heating as to control flow of heated fuel from the outlet.

13. The structure of claim 10, wherein each fuel injector includes an inlet tube defining the inlet and extending into the injector body, a portion of the means for heating element being disposed in the inlet tube.

14. The structure of claim 13, wherein a filter is disposed in the inlet tube between an end of the means for heating and the means for controlling, the end of the means for heating being generally adjacent to the filter.

15. The structure of claim 10, wherein each means for heating is constructed and arranged to receive battery voltage to cause heating of the means for heating.

16. The structure of claim 10, in combination with fuel, the fuel being at least one of E85 or E100.

17. A method of heating ethanol based fuel for an internal combustion engine, the method comprising the steps of:
providing a fuel rail receiving a source of ethanol based fuel,
providing a plurality of fuel injectors mounted to the fuel rail, each fuel injector having an injector body including an inlet for receiving the fuel and an outlet for expelling fuel,
providing heating structure associated with each fuel injector, each heating structure being mounted to the fuel rail and having a heating element extending through the fuel rail and into the inlet of the associated fuel injector, and
causing heating of the heating elements to heat the fuel prior to being expelled from the outlets of the fuel injectors.

18. The method of claim 17, wherein step of providing heating structure includes providing the heating element as one of a Positive Temperature Coefficient (PTC) element or a ceramic element constructed and arranged so that fuel flows around a periphery of the heating element.

19. The method of claim 17, wherein the step of causing heating of the heating element including providing battery voltage to the heating element.

20. The method of claim 17, wherein the step of providing the heating structure includes ensuring that the heating element extends into the injector body so that an end of the heating element is generally adjacent to a filter disposed in the injector body.
